(19) United States
(12) Patent Application Publication
(10) Pub. No.: US 2008/0052157 A1
(43) Pub. Date: Feb. 28, 2008

(54) SYSTEM AND METHOD OF DYNAMICALLY MANAGING AN ADVERTISING CAMPAIGN OVER AN INTERNET PROTOCOL BASED TELEVISION NETWORK

(76) Inventors: Jayant Kadambi, Mountain View, CA (US); Ayyappan Sankaran, San Jose, CA (US)

Correspondence Address: Global IP Services, PLLC, 198 F, 27th Cross, 3rd Block, Jayanagar, Bangalore, Karnataka, 560011, omitted

(21) Appl. No.: 11/549,120

(22) Filed: Oct. 13, 2006

Related U.S. Application Data
(60) Provisional application No. 60/823,100, filed on Aug. 22, 2006.

(51) Int. Cl. G06Q 30/00

(52) U.S. Cl. 705/14

(57) ABSTRACT

A method of dynamically managing an advertising campaign over an internet protocol based television network, the method comprising the steps of: customizing the advertising campaign based on predetermined customization parameters; in response to customizing, providing a budgeting information for the advertising campaign based on budgeting parameters and displaying a content with the advertisement in a real time based on the advertising campaign.

This application claims priority under 35 USC [symbol] 119 (e)(1) of provisional application No. 60/823100, Filed on 22 Aug. 2006

### FIELD OF INVENTION

The present invention relates generally to a method of managing an advertising campaign over a television network and more specifically to a method for providing an advertisement to a target group of consumers over an internet protocol based television network.

### BACKGROUND OF THE INVENTION

Conventionally advertisements are generated well in advance for a video content that may be sitting on a set top box or a PC client that a user may be viewing. When you watch such content in 3 months or 6 months time you still have the old advertisements playing. In a streaming environment, where the user clicks on a web page and watches a streamed video, the advertisement is pre associated with the content and doesn't change dynamically, that is even though the content is not stored and is streamed, done in real-time, the advertisement is pre-associated. Certain inconveniences are caused as a result of the conventional method that uses several tapes and causes errors caused by operator error. Additionally local advertisers cannot on many occasions afford the production cost of live action messages, and as a result spot messages are not readily available to local advertisers. While still-frame commercials (for example motionless video with accompanying audio) are known, this type of advertising is often ineffective in generating consumer interest in the promoted product as the advertisements are not customized or targeted as per the viewers interests thereby resulting in an advertising campaign that is not so cost effective.

The various patents cited below represent the prior art for ways of inserting advertisements in content.

U.S. Pat. No. US2005000177048

This patent discloses a method to monitor television programming viewed by the user and compiling a user profile characterizing the television programming. When the user requests an Internet resource, the television programming information in the user profile is utilized to select an appropriate advertisement. However, the appropriate advertisement cannot be inserted dynamically on an ongoing basis.

U.S. Pat. No. US2004000966989

This patent discloses a method of delivering a geographically targeted advertisement, if a match exists between a user information and geographical parameter. The advertisements are generally predetermined based on the user-profile and not managed dynamically on a real-time basis.

Japanese Pat. No. JP2004000032713

This patent discloses a method of evaluating an advertisement based on a bid value of the advertisement. The bid value of the advertisement is based on user information. The method further comprises proposing an appropriate advertisement to the user based on the user information.

The patents listed above identify some measures that have been taken to make advertisements more customized and targeted. But with the advent of internet based television networks, TV and video programming growing into a flood of content, there is an increasing trend towards dynamic deployment of advertisements on an on-going basis.

### BRIEF DESCRIPTION OF THE FIGURES

The accompanying figures, where like reference numerals refer to identical or functionally similar elements throughout the separate views and which together with the detailed description below are incorporated in and form part of the specification, serve to further illustrate various embodiments and to explain various principles and advantages all in accordance with the present invention.

FIG. 1 illustrates a block diagram showing an exemplary environment in which various embodiments of the present invention can function.

FIG. 2 illustrates a system and a device for managing an advertising campaign over an internet protocol based television network in accordance with various embodiments of the present invention.

FIG. 3 illustrates a flow diagram of a method for managing an advertising campaign over an internet protocol based television network in accordance with various embodiments of the present invention.

FIG. 4 illustrates a flow diagram of a method for providing a budgeting information for an advertising campaign based on budgeting parameters in accordance with various embodiments of the present invention.

### DETAILED DESCRIPTION OF THE INVENTION

Before describing in detail embodiments that are in accordance with the present invention, it should be observed that the embodiments reside primarily in combinations of method steps and apparatus components related to a system and method of managing an advertising campaign over an internet protocol based television network. Accordingly, the apparatus components and method steps have been represented where appropriate by conventional symbols in the drawings, showing only those specific details that are pertinent to understanding the embodiments of the present invention so as not to obscure the disclosure with details that will be readily apparent to those of ordinary skill in the art having the benefit of the description herein. Thus, it will be appreciated that for simplicity and clarity of illustration, common and well-understood elements that are useful or necessary in a commercially feasible embodiment may not be depicted in order to facilitate a less obstructed view of these various embodiments.

In this document, relational terms such as first and second, top and bottom, and the like may be used solely to distinguish one entity or action from another entity or action without necessarily requiring or implying any actual such relationship or order between such entities or actions. The terms “comprises,” “comprising,” “has”, “having,” “includes”, “including,” “contains”, “containing” or any other variation thereof, are intended to cover a non-exclusive inclusion, such that a process, method, article, or apparatus that comprises, has, includes, contains a list of elements does not include only those elements but may include other elements not expressly listed or inherent to such process, method, article, or apparatus. An element proceeded by “comprises . . . a”, “has . . . a”, “includes . . . a”, “contains . . . a” does not, without more constraints, preclude the existence of additional identical elements in the process, method, article, or apparatus that comprises, has, includes, contains the element. The terms “a” and “an” are defined as one or more unless explicitly stated otherwise herein. The terms “substantially”, “essentially”, “approximately”, “about” or any other version thereof, are defined as being close to as understood by one of ordinary skill in the art, and in one non-limiting embodiment the term is defined to be within 10%, in another embodiment within 5%, in another embodiment within 1% and in another embodiment within 0.5%. The term “coupled” as used herein is defined as connected, although not necessarily directly and not necessarily mechanically. A device or structure that is “configured” in a certain way is configured in at least that way, but may also be configured in ways that are not listed.

It will be appreciated that embodiments of the invention described herein may be comprised of one or more conventional processors and unique stored program instructions that control the one or more processors to implement, in conjunction with certain non-processor circuits, some, most, or all of the functions of the system and method of managing an advertising campaign over an internet protocol based television network described herein. The non-processor circuits may include, but are not limited to, a radio receiver, a radio transmitter, signal drivers, clock circuits, power source circuits, and user input devices. As such, these functions may be interpreted as steps of a method of managing an advertising campaign over an internet protocol based television network described herein. Alternatively, some or all functions could be implemented by a state machine that has no stored program instructions, or in one or more application specific integrated circuits (ASICs), in which each function or some combinations of certain of the functions are implemented as custom logic. Of course, a combination of the two approaches could be used. Thus, methods and means for these functions have been described herein. Further, it is expected that one of ordinary skill, notwithstanding possibly significant effort and many design choices motivated by, for example, available time, current technology, and economic considerations, when guided by the concepts and principles disclosed herein will be readily capable of generating such software instructions and programs and ICs with minimal experimentation.

Generally speaking, pursuant to the various embodiments, the invention provides a system and method of managing an advertising campaign over an internet protocol based television network. An internet protocol (IP) based television (TV) network can be any broadband network that allows for and facilitates the delivery of video content over IP as well as on IP-based broadband devices such as a PC, a mobile, etc. An IP based television network is a full duplex communication network that provides a feedback loop based on the number of users connected to the communication network. An advertisement can comprise at least one of a video, an audio, a graphic overlay (jpeg, gif, etc.) that is overlaid on the video stream and a text stream. While displaying the video content, the advertisement can be inserted, for instance in a timeslot before display of the video content, a predetermined timeslot during display of video content or even a timeslot after the display of video content. As per one embodiment, managing an advertising campaign over an internet protocol based television network entails, creating a customized advertising campaign, controlling the mechanism of modifying the advertising campaigns periodically and displaying the advertisements to a client on a real-time basis based on the advertising campaign. The advertising campaign can be defined as a set of rules such as a plurality of customization parameters or a plurality of budgeting parameters associated with the delivery of the advertisement; for example, when the advertisement should run, where it should run, on which content, in which region, etc. and the dates when it should run. Thus a feedback loop, which is due to the inherent full duplex communication in a broadband network, provides the ability of getting information from the users on a real time basis. The real time being a time where the advertiser can get feedback as to the number of users watching the content/the type of content etc. and he can instantly target his advertisement campaign based on the data received.

The present invention, thus, attempts to produce an experience of targeted and dynamic advertising on a real time basis for video content delivered through an internet protocol based television network as well as IP-based broadband devices such as a PC, a mobile, etc. Those skilled in the art will realize that the above recognized advantages and other advantages described herein are merely exemplary and are not meant to be a complete rendering of all of the advantages of the various embodiments of the present invention.

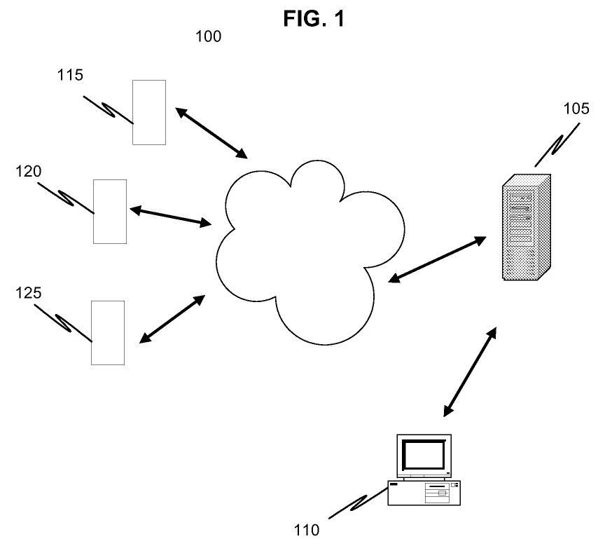

Referring now to the drawings, and in particular to FIG. 1, a block diagram showing an exemplary internet protocol based television network 100 is shown, in accordance with an embodiment of the present invention. As stated earlier the internet protocol based television network can be any broadband network that allows for and facilitates the delivery of video content over IP as well as on IP-based broadband devices such as a PC, a mobile, etc. The internet protocol based television network is illustrated with two servers 105, 110 and three display devices 115, 120 and 125 for clarity of illustration. Those skilled in the art will recognize that there can be any number of display devices and servers that can reside in different locations and the depiction shown in FIG. 1 is only for exemplary purposes.

The display devices 115, 120 and 125 can be devices that are capable of displaying any audio, video or audio-video content along with an advertisement. Such display devices can comprise a television (TV), a personal computer (PC), a laptop, a mobile phone and a personal digital assistant (PDA). The advertisement comprises at least one of a video, an audio, a graphic overlay (jpeg, gif, etc.) that is overlaid on the video stream and a text stream. The server 105 is configured for managing the advertising campaign over the internet protocol based television network. The server 105 enables modifying the advertising campaigns periodically, customizing the advertising campaigns based predetermined parameters and sending the advertisements to display devices 115, 120 and 125 on a real-time basis. The server 105 can be part of an existing content providers internal network or may even be provided by a third party service provider. For instance, the server 105 can be part of a cable operator's television network and advertisers wishing to provide customized advertisements can access the server 105 and customize the advertising campaign. The cable operator can dynamically insert the advertisements based on the advertisers preferences in the content and display the content with the advertisements to the end users display device via the IP based television network. The content to which the advertisements are inserted can reside on the server 105 or can be coming from a server 110 that is residing anywhere on the IP broadband network. The content can be completely independent from the advertisement and can be downloaded or streamed from any location. Those skilled in the art will appreciate that the delivery of the content is independent from the delivery of the advertisement that is the content can be coming from any other server residing anywhere on the IP broadband network.

For instance, a movie ‘X’ is being shown in two different locations, location ‘A’ and location ‘B’. In such a scenario the advertiser may customize the advertising campaign for each location. Location ‘A’ shall view the movie ‘X’ along with advertisements that are local to location ‘A’. While the same movie ‘X’ shall be displayed with a set of advertisements that are local to location ‘B’, which are different from the advertisements displayed in location ‘A’. As stated earlier real time being the time where the advertiser can get feedback as to the number of users watching the content/the type of content etc. and he can instantly target his advertisement campaign based on the data received. In the example stated above the advertisement can be one of a video, an audio, a graphic overlay (jpeg, gif, etc.) that is overlaid on the video stream and a text stream that is local to location ‘A’ or ‘B’ which are associated with the movie ‘X’ at the time of display. Whereas the advertisement campaign on which is based the display of advertisement, is a set of rules such as a plurality of customization parameters or a plurality of budgeting parameters which in this example is ‘location where the advertisement is to be displayed’. Since the IP based television network provides a feedback loop, dynamic customization of the advertising campaign based on several factors is enabled.

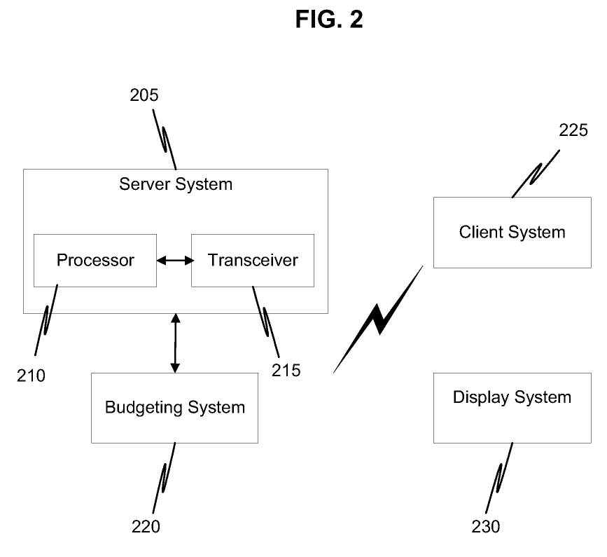

Turning now to FIG. 2, a system and a device for managing an advertising campaign over an internet protocol based television network is shown in accordance with various embodiments of the present invention. In accordance with the present invention there are a plurality of content providers such as television channels or cable operators who have content or whose content is already being played or web sites with video content. As stated earlier the content can be completely independent from the advertisement and can be downloaded or streamed from any location. There are also a plurality of advertisers who wish to provide advertisements in specific content displayed by content providers. An embodiment of the present invention provides a system for managing the advertising campaign over an internet protocol based television network that is associated with the content providers. The choice of location for a server to enable management of the advertising campaign can be influenced by business considerations. For example, some business considerations may dictate that the advertisers will have to log into a third party service provider for managing the advertising campaign over the internet protocol based television network to access its services while other considerations may dictate that the system for managing the advertising campaign over the internet protocol based television network be sold or licensed to the content provider who in turn will interact with the advertisers. Those skilled in the art will recognize that the working details of the system for managing the advertising campaign over the internet protocol based television network would differ slightly based on the implementation and the associated business model and all such implementations are within the scope of the present invention.

Referring now to FIG. 2, as per the embodiment, the system for managing the advertising campaign over the internet protocol based television network comprises a server system 205 coupled with a budgeting system 220, a client system 225 and a display system 230. The system for managing the advertising campaign over the internet protocol based television network enables continuous modifying or creating the advertising campaigns, customizing the advertising campaigns based on their locations and sending the advertisements to display devices in real-time basis. As stated earlier the advertising campaign can be defined as a set of rules such as a plurality of predetermined customization parameters or a plurality of predetermined budgeting parameters, associated with the delivery of the advertisement; for example, when the advertisement should run, where it should run (on which content, in which region, etc.) and the dates when it should run. The server system 205 is configured to display predetermined customization parameters related to the advertising campaign. The server system 205 comprises a processor 210 and a transceiver 215. The transceiver 210 is operatively coupled to the processor 215 that creates the advertising campaign based on predetermined customization parameter and sends a content with the advertisements. The predetermined customization parameters comprise a geography for the advertisement, a number of viewers of the advertisement, a psychographic information of viewers of the advertisement, a demographic information of viewers of the advertisement, a timeslot for displaying the advertisement, a plurality of dates for displaying the advertisement, a content for displaying the advertisement, a plurality of responses received from viewers of the advertisement and a budgeting parameters for the advertisement. Those skilled in the art shall appreciate that several customization parameters can be taken into consideration based on the requirements and all such customization parameters are within the scope of the present invention.

The server system 205 is coupled to a budgeting system 220 that is configured to provide budgeting information for the advertising campaign based on budgeting parameters. The budgeting system 220 is configured such that it displays a cost per view (CPV) estimate based on the predetermined customization parameters. The advertiser of the advertising campaign is provided with the ability to modify the CPV based on the budgeting parameters. The budgeting parameters are an advertising estimate chosen by an advertiser of the advertisement. For instance, an advertiser may wish to spend a limited amount on the advertising campaign and may pay based on the number of end-users actually viewing the advertisement. The system provides such information to the user based on the previous viewership or number of end-users that have requested for a particular content to be viewed, or based on the number of end-users watching the content on a real-time basis. Additionally, the budgeting parameters can also be based on at least one of a time slot for the advertisement, competition for the time slot, a date range for which the advertisement is valid, a maximum CPV desired to be spent by the advertiser; responses to the advertisement received by the advertiser. As per one embodiment of the present invention the budgeting system 220 can be a part of the server system 205.

The system for managing the advertising the advertising campaign over the internet protocol based television network further comprises the client system 225. The client system is present at the advertiser's end where the customization parameters are displayed. For instance, the advertiser can user a web browser to access the server and customize the advertising campaign via the web browser. Once the advertiser has selected the customization parameters and provided the advertising campaign, the advertisement is dynamically inserted with the content and the advertisement along with the content is displayed to an end user display system 230 over the internet protocol based television network as well as on IP-based broadband devices such as a PC, a mobile, etc. As per another embodiment of the present invention the advertisement can be displayed based on a bidding mechanism prior to displaying the content with the advertisement or in real-time during playback of the content. Those skilled in the art shall recognize that the advertising campaign can be modified continuously in real-time based on responses received from viewers of the advertisement as a result of the feedback loop, which is due to the inherent full duplex communication in a broadband network.

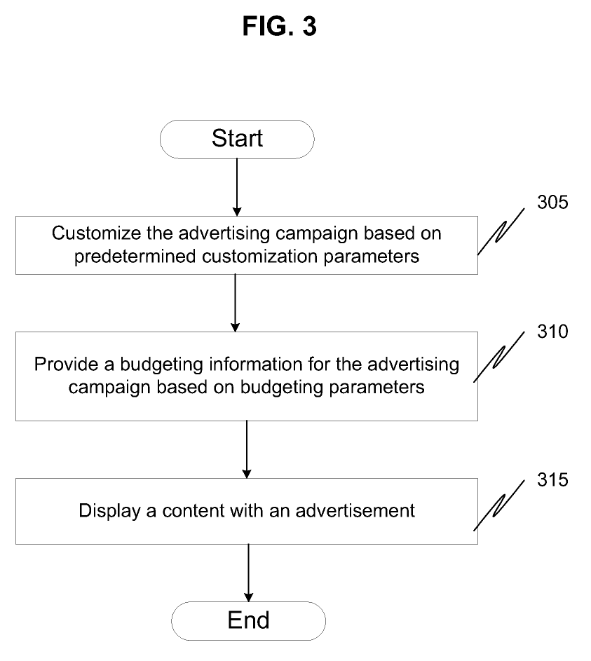

Turning now to FIG. 3, a flow diagram of a method for managing an advertising campaign over an internet protocol based television network is shown in accordance with an embodiment of the present invention. The method for managing the advertising campaign over the internet protocol based television network comprises creating an advertising campaign wherein advertisers have to specify the name of the advertising campaign, the description of the advertising campaign, the available options of whether the advertiser wants customer targeting by location for the advertising campaign or customize the advertising campaign with scrolling text that varies by region the region, region where the advertising campaign needs to run, provide or upload the actual video file, audio stream, a graphic overlay (jpeg, gif, etc.) that is overlaid on the video stream and a text stream for the advertising campaign. As it has been stated already the advertisement can be inserted in at least one of a timeslot before display of content, a predetermined timeslot during display of content, a timeslot after display of content. Depending on the options specified by the advertiser the system is data mined for providing an predicted estimate of the number of people that are going to watch each content that is available based on the viewing pattern as well as the content that has been watched in the previous week or the content that is being watched since the content is downloaded and put in a queue. The estimate of the number of people can be generated for content ‘X’ based on the previous weeks viewer ship or based on monitoring the number of requests made for a movie ‘Y’ to be telecast on a particular date. As a result this provides a reasonably accurate estimate of the number of people watching the content on the system and enables in selecting one or more content for which the advertisement can be run.

Upon creating the advertising campaign and selecting the content for the advertising campaign, the method for managing the advertising campaign over the internet protocol based television network comprises at step 305, customizing or targeting the advertising campaign based on predetermined customization parameters which are a set of rules associated with the advertisement at the time of display. The predetermined customization parameters comprise a geography for the advertisement, a number of viewers of the advertisement, a psychographic information of viewers of the advertisement, a demographic information of viewers of the advertisement, a timeslot for displaying the advertisement, a plurality of dates for displaying the advertisement, a content for displaying the advertisement, a plurality of responses received from viewers of the advertisement and a budgeting parameters for the advertisement.

For example, targeting the advertising campaign based on a set of rules such as predetermined customization parameter of targeting by geography is when the advertiser specifies that he wants to telecast the advertisement for only those people in San Jose, Calif. within a particular pin code and people in Fremont Calif. within a particular pin code. In an embodiment of the present invention the data that is mined for providing the information for targeting the advertising campaign can be generated by having a questionnaire filled in by subscribers of the service thereby providing the advertisers with different kind of information for targeting the advertising campaign. Also information on the subscribers is captured at the time the subscriber uses his/her credit card for subscribing for the services. Thus customization of the advertising campaign can be enabled by providing the subscribers with a user interface with check boxes or drop down selection box, text box etc to be able to select various options from the predetermined customization parameters associated with the delivery of the advertisement; for example, a time slot when the advertisement should run, geographic information of where the advertisement should run (on which content, in which region, etc.) and the dates when it should run etc.

Another example can be customizing the advertising campaign of an ABC airlines based on predetermined customization parameter of the geography for the advertisement. The ABC airlines advertisement video can be played in India for travel to destinations via the ABC airline in all India Vs Pakistan cricket matches. Customization of the video track of the ABC airlines advertisement can be done by customizing the audio track or the text track of the advertisement to flash on the screen while the video track is being played with the flight tariff details of Mumbai to the destination of the cricket match for viewers in Mumbai and the flight tariff details of Bangalore to the destination of the cricket match for viewers in Bangalore for the same video track. In the above example the ABC airline video with the customized audio track and text track is the actual advertisement that is displayed based on the advertising campaign which is in turn based on the set of rules such as a plurality of predetermined customization parameters for example, the geography of the advertisement to be played in this case, is associated with the advertisement at the time of display.

Another example can be of customizing the advertising campaign and dynamically inserting the advertisement in the content to be displayed. For instance, an online bookstore may wish to display advertisements regarding the books that the bookstore sells. In such situations, while broadcasting a movie such as ‘Jurassic Park’, a scrolling text of books pertaining to dinosaurs can be displayed when images of dinosaurs are being shown. Displaying the advertisement at such times provides context to the viewer of the content and may lead to greater conversions. Conventionally, advertisements could only be displayed at predetermined time slots within the content and not dynamically at specific instances within the move content. In the above example the bookstore advertisement with the customized scrolling text of books pertaining to dinosaurs is the actual advertisement that is displayed based on the advertising campaign which is in turn based on the set of rules such as a plurality of predetermined customization parameters, for example, the context of the content which is the ‘Jurassic park’ movie in this case, is associated with the advertisement at the time of display.

Another example can be of customization of pizza shop advertisement for customizing or targeting the advertising campaign is based on predetermined customization parameter of the time slot for displaying the advertisement. The pizza shop advertiser wants the pizza advertisement to flash in the content of a movie played between 8 pm to 9 pm for all those subscribing to the service within 2 sq mile area of the pizza shop. This advertisement can be further customized by dynamically adding a text crawler offering a discount on the pizza's ordered during 8 pm to 9 pm, for the viewers in the 2 sq mile area of the pizza shop. Thus by customizing the audio track or the text track for the same video track enables the advertiser in deciding where the advertisements should be played for the total content selected for playing the advertisements. It will be appreciated that the advertising campaign can be modified continuously in real-time based on responses received from viewers of the advertisement. The IP based television network enables the ability to obtain such information of the end-user and dynamically insert such advertisements on a real-time basis within the content. As stated earlier a feedback loop, which is due to the inherent full duplex communication in a broadband network enables in getting information from the users on a real time basis.

Upon customizing or targeting the advertising campaign based on as a set of rules such as a plurality of predetermined customization parameters or a plurality of predetermined budgeting parameters, the method for managing the advertising campaign over the internet protocol based television network comprises at step 310, providing a budgeting information for the advertising campaign based on budgeting parameters. The budgeting parameters are an advertising estimate chosen by an advertiser of the advertisement. Having selected the options based on the budgeting parameters, at step 315 the content is displayed with the advertisement to the end-user display device via the IP based television network.

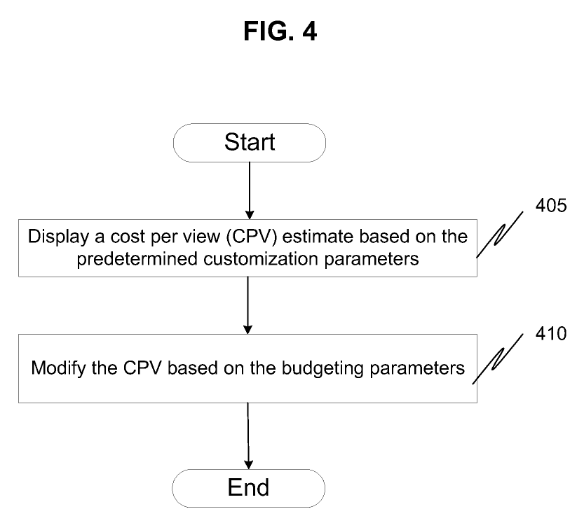

Turning now to FIG. 4, a flow diagram of a method for providing budgeting information for the advertising campaign based on budgeting parameters in accordance with various embodiments of the present invention is shown. The method for providing the budgeting information for the advertising campaign comprises, at step 405 displaying a cost per view (CPV) estimate based on the predetermined customization parameters. Based on the advertising campaign time that is the start time and the end time for which the advertisement will run and the competition for that slot, the system will calculate a suggested maximum CPV and estimated subscribers that will be reached and the costs that will result. The advertiser can accept the suggested maximum CPV or enter one of his/her own. Upon displaying the cost per view (CPV) estimate based on the predetermined customization parameters, the CPV can be modified based on the budgeting parameters at step 410. As per an embodiment of the present invention the advertiser is allowed to control the expenditure to be incurred on the advertising campaign. For example if the advertisement is to be displayed at a CPV of 2$ per viewer, for 10,000 viewers, the display of the advertisement is cut off as soon as it has reached the cost of 20,000$.

The budgeting parameters are an advertising estimate chosen by an advertiser of the advertisement. The budgeting parameters can be based on at least one of a time slot for the advertisement, competition for the time slot, a date range for which the advertisement is valid, a maximum CPV desired to be spent by the advertiser; responses to the advertisement received by the advertiser. The advertisement can be inserted in at least one of a timeslot before display of content, a predetermined timeslot during display of content, a timeslot after display of content. The advertisement can be displayed based on a bidding mechanism just prior to displaying the content with the advertisement or in real-time during playback of the content. This enables auctioning the advertisement slot at the time of playing content or a movie.

An example of the bidding mechanism is explained herein below. As stated earlier an estimate of the number of people going to watch a particular content on a particular day can be data mined from the database. The information regarding the advertisement slots available for a particular content, for example a half hour show for that particular day is provided. For instance, there are three advertisement slots before the half hour serial, a graphic overlay (jpeg, gif, etc.) that is overlaid on the video stream, branding slot that is overlaid during the serial and there are two advertisement slots in the middle of the half hour serial. Based on the bidding, for example the highest CPV entered by advertisers for the advertising slot for the half hour serial, the advertisement slots are auctioned. Those skilled in the art will appreciate that the advertisement can be displayed based on a bidding mechanism just prior to displaying the content with the advertisement or in real-time during playback of the content.

The present invention provides a method and system of managing an advertising campaign over an internet protocol based television network. It further enables managing the advertising campaign over the internet protocol based television network includes a controlling the mechanism of modifying the advertising campaigns continuously and sending the advertisements to a client in real-time basis and provides online performance reports 24/7 in the account. Additionally, ensures no monthly minimum spending limit or time commitment and only a minimal fee to set up your account. Also the cost-per-view (CPV) pricing ensures that the advertiser pays only for the viewers who have seen the advertisement at a price he has set. The present invention, thus, attempts to produce an experience of targeted and dynamic advertising in a real time basis.

In the foregoing specification, specific embodiments of the present invention have been described. However, one of ordinary skill in the art appreciates that various modifications and changes can be made without departing from the scope of the present invention as set forth in the claims below. Accordingly, the specification and figures are to be regarded in an illustrative rather than a restrictive sense, and all such modifications are intended to be included within the scope of present invention. The benefits, advantages, solutions to problems, and any element(s) that may cause any benefit, advantage, or solution to occur or become more pronounced are not to be construed as a critical, required, or essential features or elements of any or all the claims. The invention is defined solely by the appended claims including any amendments made during the pendency of this application and all equivalents of those claims as issued.

What is claimed is:

1. A method of dynamically managing an advertising campaign over an internet protocol based television network, the method comprising:
customizing the advertising campaign based on predetermined customization parameters;
providing a budgeting information for the advertising campaign based on budgeting parameters; and
displaying a content with an advertisement in a real time based on the advertising campaign.

2. The method of claim 1, wherein the predetermined customization parameters comprise a geography for the advertisement, a number of viewers of the advertisement, a psychographic information of viewers of the advertisement, a demographic information of viewers of the advertisement, a timeslot for displaying the advertisement, a plurality of dates for displaying the advertisement, a content for displaying the advertisement, a plurality of responses received from viewers of the advertisement and a budgeting parameters for the advertisement.

3. The method of claim 2, wherein the advertising campaign can be modified continuously in real-time based on responses received from viewers of the advertisement.

4. The method of claim 1, wherein the providing step further comprises:
displaying a cost per view (CPV) estimate based on the predetermined customization parameters; and
modifying the CPV based on the budgeting parameters.

5. The method of claim 4, wherein the budgeting parameters is an advertising estimate chosen by an advertiser of the advertising campaign.

6. The method of claim 5, wherein the budgeting parameters can be based on at least one of a time slot for the advertisement, competition for the time slot, a date range for which the advertisement is valid, a maximum CPV desired to be spent by the advertiser; responses to the advertising campaign received by the advertiser.

7. The method of claim 1, wherein the advertisement can be displayed based on a bidding mechanism prior to displaying the content with the advertisement or in real-time during playback of the content.

8. The method of claim 1, wherein the advertisement can be inserted in at least one of a timeslot before display of content, a predetermined timeslot during display of content, a timeslot after display of content.

9. The method of claim 1, wherein the advertisement is at least one of a video, an audio, a graphic overlay and a text stream.

10. A system for dynamically managing an advertising campaign over an internet protocol based television network, the system comprising:
a server system configured to display predetermined customization parameters related to an advertising campaign;
a client system configured to select customization parameters for the advertising campaign;
a budgeting system coupled to the server system configured to provide budgeting information for the advertising campaign based on budgeting parameters; and
a display system to display an advertisement based on the advertising campaign with a content over the internet protocol based television network.

11. The system of claim 10, wherein the predetermined customization parameters comprise a geography for the advertisement, a number of viewers of the advertisement, a psychographic information of viewers of the advertisement, a demographic information of viewers of the advertisement, a timeslot for displaying the advertisement, a plurality of dates for displaying the advertisement, a content for displaying the advertisement, a plurality of responses received from viewers of the advertisement and a budgeting parameters for the advertisement.

12. The system of claim 11, wherein the advertising campaign can be modified continuously in real-time based on responses received from viewers of the advertisement.

13. The system of claim 10, wherein the budgeting system is configured to display a cost per view (CPV) estimate based on the predetermined customization parameters, the advertiser of the advertisement being provided with the ability to modify the CPV based on the budgeting parameters.

14. The system of claim 13, wherein the budgeting parameters can be based on at least one of a time slot for the advertisement, competition for the time slot, a date range for which the advertisement is valid, a maximum CPV desired to be spent by the advertiser; responses to the advertisement received by the advertiser.

15. The system of claim 10, wherein the advertisement can be displayed based on a bidding mechanism prior to displaying the content with the advertisement or in real-time during playback of the content.

16. The system of claim 10, wherein the budgeting system can be a part of the server system.

17. The system of claim 10, wherein the server system can display the predetermined customization parameters using a webpage accessed by the client system using the Internet.

18. A device for dynamically managing an advertising campaign over an internet protocol based television network, the device comprising.
a processor;
a transceiver operatively coupled to the processor and adapted for:
creating an advertising campaign based on predetermined customization parameters;
providing a budgeting information for the advertising campaign based on budgeting parameters; and
sending a content with an advertisement.

19. The device of claim 18, wherein the advertising campaign is created by an advertiser using the predetermined customization parameters.
